(19) United States
(12) Patent Application Publication
(10) Pub. No.: US 2008/0230739 A1
(43) Pub. Date: Sep. 25, 2008

(54) Hydrofluorocarbon-Based Composition

(75) Inventors: Laurent Caron, Sainte Foy Les Lyon (FR); Agnes Tamin, Brindas (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, COLOMBES (FR)

(21) Appl. No.: 12/089,567

(22) PCT Filed: Aug. 24, 2006
(86) PCT No.: PCT/FR2006/050810

§ 371 Date: Apr. 8, 2008

(30) Foreign Application Priority Data
Oct. 14, 2005 (FR) 0510484

(51) Int. Cl. C09K 5/04

(52) U.S. Cl. 252/67

(57) ABSTRACT

The objective of the present invention is to provide a composition capable of being used as a refrigerant and which corresponds to the desire for a reduced environmental impact.

The composition according to the present invention comprises from 15-25 wt % of difluoromethane (HFC-32), 50-60 wt % of pentafluoroethane (HFC-125), 15-25 wt % of 1,1,1,2 tetrafluoroethane (HFC-134a) and 1-3 wt % of propene (HC-1270).

The present invention relates to a composition based on hydrofluorocarbons (HFCs) capable of being used in refrigeration.

The azeotrope composed of 48.8 wt % of chlorodifluoromethane (HCFC-22 or R-22) and 51.2 wt % of chloropentafluoroethane (CFC-115), known under the name R-502, has been widely used as a refrigerant in superstore (supermarket) refrigerators. Due to the damaging effect caused by chlorinated compounds on the ozone layer, this product, a member of the family of chlorofluorocarbons (CFCs), is now banned in many countries. It has been replaced by the hydrochlorofluorocarbon (HCFC) 22 or mixtures comprising HCFC-22 for existing equipment. It has been replaced by hydrofluorocarbon-based mixtures for new equipment. Thus, a ternary mixture composed of 44 wt % of pentafluoroethane (HFC-125), 52 wt % of 1,1,1 trifluoroethane (HFC-143a) and 4 wt % of 1,1,1,2-tetrafluoroethane (HFC-134a), known under the name R-404A has been used to replace R-502.

However, in view of the increasing severity of environmental regulations, it is desirable to provide a replacement for R-404A as its GWP (global warming potential), equal to 3260, places it among the last generation HFC refrigerants having the greatest intrinsic impact on global warming.

Furthermore, a non-azeotropic composition comprising 10-90 wt % of difluoromethane (HFC-32), 10-90 wt % of HFC-125, 10-60 wt % of propene (HC-1270), 10-90 wt % of HFC-134a and which may contain up to 20 wt % of impurities is known from document CN 1183451 A.

A refrigerant composition, for replacing HCFC-22, containing from 10-25 wt % of HFC-32, from 20-60 wt % of HFC-125, from 20-60 wt % of HFC-134a and from 2-5 wt % of a hydrocarbon or of a mixture of hydrocarbons having from 3 to 5 carbon atoms is described in document JP 2004/175998.

Document US 2004/0061091 describes a mixture, for replacing HCFC-22, composed of 20-60wt % of HFC-134a, 40-70wt % of HFC-125, 1-10 wt % of HFC-32 and 1-8 wt % of a hydrocarbon mixture.

The objective of the present invention is to provide a composition capable of being used as a refrigerant and which corresponds to the desire for a reduced environmental impact.

A first subject of the present invention is therefore a composition comprising 15-25 wt % of difluoromethane (HFC-32), 50-60 wt % of pentafluoroethane (HFC-125), 15-25 wt % of 1,1,1,2 tetrafluoroethane (HFC-134a) and 1-3 wt % of propene (HC-1270).

The composition according to the present invention preferably comprises 17-23 wt % of difluoromethane (HFC-32), 50-58 wt % of pentafluoroethane (HFC-125), 20-25 wt % of 1,1,1,2 tetrafluoroethane (HFC-134a) and 1-3 wt % of propene (HC-1270).

Advantageously, the composition according to the present invention comprises 19-21 wt % of difluoromethane (HFC-32), 53-58 wt % of pentafluoroethane (HFC-125), 21-23 wt % of 1,1,1,2 tetrafluoroethane (HFC-134a) and 1-3 wt % of propene (HC-1270).

Another subject of the present invention is a refrigerant having a composition according to the first subject. Another subject of the invention is the use of the refrigerant as a replacement for R-404A.

### EXAMPLES

The performances of R-32/125/1270/134a mixtures have been compared with that of R-22 and those of R-404A on the following refrigeration output cycle:

Evaporation temperature: −40° C.;

Condensation temperature: +30° C.;

Subcooling: 5 K; and

Superheating: 25 K.

The compositions of this invention tested are given by the following table.

| wt % | R-32 | R-125 | R-1270 | R-134a |
|---|---|---|---|---|
| Example 1 | 20 | 56 | 1 | 23 |
| Example 2 | 20 | 57 | 1 | 22 |
| Example 3 | 20 | 56 | 2 | 22 |

The following table provides, for each of the formulations, the refrigeration capacity (CAPA), namely the amount of refrigeration produced (kJ) per unit of aspirated volume (m³), the COP (ratio of the cooling power to the power absorbed by the fluid at the compressor), the condensation pressure (bar) and the GWP.

| | CAPA vs R-404A | COP vs R-404A | Cond. P | |
|---|---|---|---|---|
| | in % | in % | bar | GWP |
| R-404A | +0 | 0 | 14.3 | 3260 |
| R-22 | −13.8 | −0.75 | 11.9 | 1700 |
| Example 1 | −2.6 | −1.6 | 14.6 | 2000 |
| Example 2 | −1.7 | −1.7 | 14.7 | 2010 |
| Example 3 | −1.6 | −1.6 | 14.7 | 1980 |

It can be observed that the compositions of this invention have performances (COP, CAPA) similar to those of R-404A, better than those of R-22 for a GWP significantly lower than that of R-404A and of the same order of magnitude as that of R-22. Moreover, the pressure levels remain suitable for those of a R-404A piece of equipment.

1. A composition comprising 15-25 wt % of difluoromethane (HFC-32), 50-60 wt % of pentafluoroethane (HFC-125), 15-25 wt % of 1,1,1,2 tetrafluoroethane (HFC-134a) and 1-3 wt % of propene (HC-1270).

2. The composition as claimed in claim 1, characterized in that it comprises 17-23 wt % of difluoromethane (HFC-32), 50-58 wt % of pentafluoroethane (HFC-125), 20-25 wt % of 1,1,1,2 tetrafluoroethane (HFC-134a) and 1-3 wt % of propene (HC-1270).

3. The composition as claimed in claim 1, characterized in that it comprises 19-21 wt % of difluoromethane (HFC-32), 53-58 wt % of pentafluoroethane (H FC-125), 21-23 wt % of 1,1,1,2 tetrafluoroethane (HFC-134a) and 1-3 wt % of propene (HC-1270).

4. A refrigerant as claimed in claim 1.

5. The use of the refrigerant as claimed in claim 4, as a replacement for R-404A.
